(19) United States
(12) Patent Application Publication
(10) Pub. No.: US 2009/0039231 A1
(43) Pub. Date: Feb. 12, 2009

(54) Pole Attachment Device

(76) Inventor: William Glenn McLaughlin, Joshua Tree, CA (US)

Correspondence Address: ERIC HANSCOM, 7395 PORTAGE WAY, CARLSBAD, CA, 92011, US

(21) Appl. No.: 11/836,794

(22) Filed: Aug. 10, 2007

(51) Int. Cl. F16M 13/02; A01K 97/10

(52) U.S. Cl. 248/535; 29/700

(57) ABSTRACT

An attachment device comprising a base unit that is secured to a vehicle, and a gripping unit that can be easily attached to and removed from the base unit. Pool cleaning poles, or other elongated members such as gardening tools, ladders, and skis, of various dimensions can be secured to the gripping unit. This allows the pole to be easily secured to a vehicle yet also easily removed from the vehicle while still attached to the gripping unit. Once the poles are secured to the gripping unit, the gripping unit easily slides into the base unit, securing it and the poles to the vehicle. Because the gripping unit is separate from the base unit, gripping units of various sizes can be interchangeably used, allowing for the securing of one or more poles to one base unit. The same device can be used in a garage or other storage facility.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of attachment devices, and more specifically toward a pole attachment device comprising a base unit that is secured to a vehicle, and a gripping unit that can be easily attached to and removed from the base unit. Poles, or other elongated members, of various dimensions can be secured to the gripping unit. This allows the pole to be easily secured to a vehicle, yet also easily removed from the vehicle while still attached to the gripping unit. Once the poles are secured to the gripping unit, the gripping unit easily slides into the base unit, securing it and the poles to the vehicle. Because the gripping unit is separate from the base unit, gripping units of various size can be interchangeably used, allowing for the securing of one or more poles to one base unit.

People often attach poles or the like to their vehicles, either for their occupation or recreation. For example, gardeners must carry rakes, shovels, and the like, all with long handles in their vehicles to various locations. Pool cleaners must carry long poles to reach into the depths of pools. Skiers carry long skis and poles to the mountains. Often, however, these individuals don't have an enclosed space large enough to house such items and resort to attaching them to the beds of trucks or on the roofs of cars. This, however, can have dangerous consequences. If not secured properly, these items can fall from the moving vehicle and cause damage not only to the item that fell, but also to other vehicles on the road that may come into contact with the fallen item.

An additional problem with allowing a long object to hang over the tailgate of a pickup truck is that the pole may shift position from time to time and eventually chip the paint or otherwise damage the vehicle. For trades such as pool cleaning, an attractive, well-maintained truck is very important, as customers will frequently assume that a pool cleaning technician with a beat-up truck with chipped paint will perform a lesser quality of work as would a technician with a clean, newer-looking truck.

Various means have been used to secure such items to the vehicle. Rope or bungee cords are often used to secure these items, but are often time consuming and unreliable. There are attempts by the prior art to secure items to the vehicle by various means, but these devices are often cumbersome and inefficient to use.

Examples of the prior art include Jenkins, U.S. Pat. No. 6,619,485, which discloses a rack for securing lawn tools that bolts onto a truck bed, van, or trailer. It can be used to secure law equipment, such as a grass trimmer, to a gardener's vehicle for safe transportation and can be locked to prevent theft. Hawie, U.S. Pat. No. 6,561,471 teaches a bracket for holding fishing rods. The bracket is permanently attached to a fixed object. The fishing rod can be secured inside the bracket by closing a latch, and removed from the bracket by squeezing the bracket to open the latch.

Elkins, U.S. Pat. No. 4,648,516 discloses a gun mount that has open cradles to support guns that are being transported in a vehicle or displayed on a wall. The cradles are open and do not latch closed, allowing for easy and quick removal, but keeping the guns less secure fastened to the rack.

Eckhart, U.S. Pat. No. 5,449,100 discloses a ski rack that attaches to the back of a vehicle. The ski rack secures the skis in an upright position in brackets with latches that open and close, but the brackets cannot be easily removed from the rack.

Thus there has existed a long-felt need for a pole attachment device, which can allow various shaped and sized poles, or like items, to be easily secured to a vehicle, but also easily removed from the vehicle, without attaching the device to the pole, or like item, each time it is to be secured.

The current invention provides just such a solution by having a pole attachment device comprising a base unit, preferably made of metal, that is secured to a vehicle, and a gripping, pole-attaching unit, preferably made of plastic, that can be easily attached to and removed from the base unit. A spring-loaded pin that clamps over a projection in the gripping unit. Poles, or other elongated members, of various dimensions can be secured to the gripping, pole-attaching unit. This allows the pole to be easily secured to a vehicle, yet also easily removed from the vehicle while still attached to the gripping unit. Once the poles are secured to the gripping unit, the gripping unit easily slides into the base unit, securing it and the poles to the vehicle. Because the gripping unit is separate from the base unit, gripping units of various sizes can be interchangeably used, allowing for the securing of one or more poles to one base unit, or of different shapes of objects, depending upon the desires of the user. For example, a pool technician who also skis could use a gripping unit designed for swimming pool poles during the week, then remove that gripping unit along with the poles, and insert a different gripping unit attached to a set of skis and ski poles for a weekend of skiing.

The gripping unit can be manufactured in a variety of colors and shapes. Color choices could include colors designed to match the colors of specific cars or trucks, or could be part of an organizational scheme. For example, in a swimming pool business, red gripping units could always have two gripping receptacles, and these receptacles could fit a standard pool net and a standard pool sweeper. Green gripping units could hold other types of pool tools, thereby allowing a pool maintenance person to grab the right tool even if the head portion of the tool was buried under some other items.

While the preferred embodiment of this invention is for use on a vehicle, it is also contemplated that the base unit of the invention could be attached to a garage wall, boat, or other structure with one or more sides, and function in a similar manner.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

It is a principal object of the invention to provide a device that can allow for a pole, or like item, to be easily secured to a vehicle without scratching the paint or otherwise damaging the vehicle.

It is another principal object of the invention to provide a device that can allow for a pole, or like item, to be easily removed from a vehicle and used without removing the pole, or like item, from the device.

It is another object of the invention that the invention be customizable with different sized and shaped pole-attaching units.

A further object of the invention is to provide a novel rack for hanging tools and other items from the wall of a garage or other structure.

It is a final object of this invention to provide a device that can remain attached to the pole, or like item, while it is being used or transported away from the vehicle.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a perspective view of the device with its main components separated from each other.

FIG. 2 is a perspective view of the device with its main components assembled.

FIG. 3 is a perspective view of the device from a different angle showing the use of a pin to retain the gripping unit in the base unit.

FIG. 4 is a side view of the device attached to the side wall of a pickup truck bed.

FIG. 5 is a perspective view of the device with a pool pole attached to it, with the device attached to the side of a pickup truck bed.

FIG. 6 is an end view of the device with a pool pole attached to it, with the device attached to the side of a pickup truck bed.

FIG. 7 is a cross-sectional view of the pin device which allows for selective retention or release of the gripping unit.

### DETAILED DESCRIPTION OF THE FIGURES

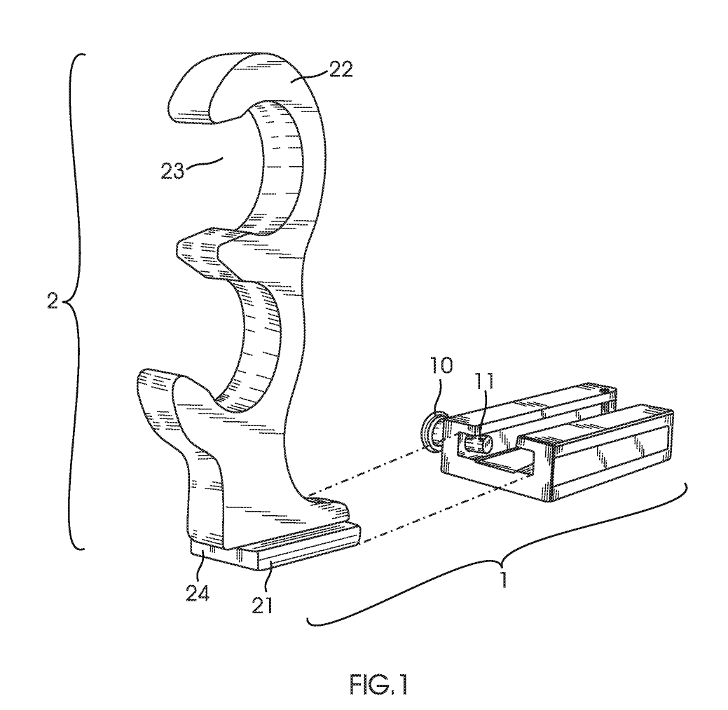

FIG. 1 is a perspective view of the device with its main components separated from each other. The device comprises a gripping unit, generally indicated by reference number 2, and a base unit, generally indicated by reference number 1. The base unit is designed to be attached to any solid object, preferably to the inside of a pickup truck bed. The base unit has a bottom section and two, “C-shaped” side sections, which define a roughly rectangular cavity or female coupling, extending almost the entire length of the base unit, with a stopping device at the bottom of the roughly rectangular cavity. At the upper end of the base unit there is a pin with a pin sleeve (not shown in this figure), a pull head 10 and a shaft 11, protruding through a hole in one side of the base unit. In between the pull head 10 and the side of the base unit is a spring which in its relaxed position forces the shaft 11 into the roughly rectangular cavity, but when the pull head 10 is pulled outward, the spring is “loaded” and allows the shaft 11 to be removed from the roughly rectangular cavity.

The gripping unit has a gripping section 22, which comprises one or more partial circles with an opening 23, into which a circular rod, such as that found on a pool cleaning pole, can be removably secured. The gripping unit also has a male coupling section 21, which has a flat back portion and thin, protruding side portions, shaped such that it can slide into and out of roughly rectangular cavity in the base unit 1. The male coupling section 21 has a stop 24 on its upper end, which is located slightly below the upper side of the gripping section 22, such that when the male coupling section 21 of the gripping unit 2 is slid into the roughly rectangular cavity of the base unit, the pull head 10 of the pin can be pulled outwardly from the side of the base unit to allow the male coupling section to slide past the shaft 11 of the pin until the male coupling section hits the stopping device at the bottom of the roughly rectangular cavity.

The gripping section 22 in this embodiment of the invention has a roughly circular member of semi-flexible material formed into the shape of a “C”, where the ends slightly converge on one other, or pincer in, to form a circular cavity, bounded and defined on approximately 60% of its sides by the roughly circular member. This creates a circular receptacle into which a circular pole can be removably inserted by merely apply sufficient force to push the pole past the pincering ends of the member. The pole can likewise be removed from the cavity by giving it a tug or pull sufficient to bend outward the pincering ends of the member sufficiently to allow the pole release from their grip. While the embodiment shown here calls for circular gripping sections useful for pool cleaning pole, fishing poles, and other round pole-like objects, rectangular gripping sections can be used for ladders, skis, and other thin and flat objects, and larger gripping sections can be used for surfboards and other larger objects with different shapes. It is envisioned that various types and shapes of gripping units can be made that all have a similar sized and shaped male coupling section, such that a number of different gripping units can be used with one base unit depending on the type of items that are being carried in the pickup truck.

It is also contemplated that the base units can be mounted on any surface to which an object can be mounted. For example, garage walls could have a number of base units attached upon which a variety of gripping units could hold a variety of objects. The sides and deck of a boat or trailer could also be used for points of attachment for base units. In terms of vehicles, while the preferred embodiment of this invention attaches to the inner side of a pickup truck bed, the base units could also be attached to the sides and roof of other vehicles.

When the pull exerted on the pull head 10 of the pin is released, the spring (not shown in this figure), causes the shaft 11 of the pin to protrude through the hole in the side of the base unit and prevent the stop 24 of the male coupling unit 21 from exiting the base unit.

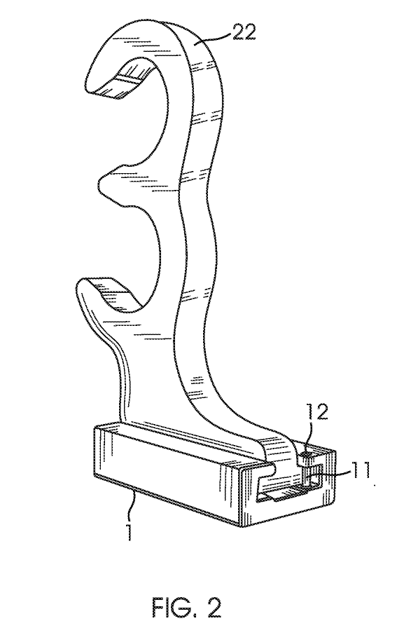

FIG. 2 is a perspective view of the device with its main components assembled. The gripping section 22 has been inserted into the base unit 1. The shaft 11 of the pin has been allowed to protrude through the hole in the side of the base unit and enter a receiving hole 12 on the other side of the base unit, thereby locking the male coupling section 21 into the base unit. It is envisioned that shafts such as those extending all the way across the roughly rectangular cavity, such as that illustrated in FIG. 2, and those merely protruding part way across the roughly rectangular cavity, such as that illustrated in FIG. 1, would both effectively retain the gripping section 22 in the base unit 1 until the pull head (not shown in this Figure) is pulled out.

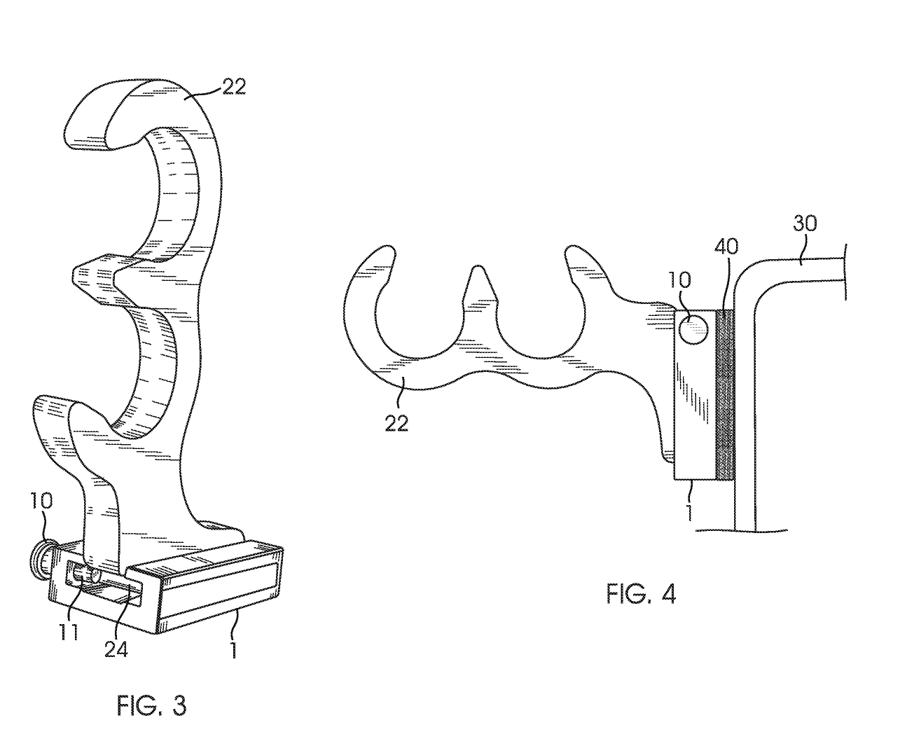

FIG. 3 is a perspective view of the device from a different angle showing the use of a pin to retain the gripping unit in the base unit. The shaft 11 of the pin protrudes partway across the roughly rectangular cavity in the base unit 1.

FIG. 4 is a side view of the device attached to the side wall of a pickup truck bed. In this figure, the gripping section 22 has been slid down into the roughly rectangular cavity of the base unit. The pull head 10 of the pin has been pulled outward to allow the gripping section 22 to slide down the roughly rectangular cavity past the pin, whereupon the pull head 10 of the pin has been released, allowing the pin to re-enter the roughly rectangular cavity and retain the gripping section 22 inside the roughly rectangular cavity of the base unit 1. The base unit 1 is attached to the side 30 of the pickup truck bed by a means of attachment 40. The means of attachment is preferably double-sided sticky, industrial strength tape, but can also be magnets, screws, bolts, or any other known means of attachment.

FIG. 5 is a perspective view of the device with a pool pole attached to it, with the device attached to the side of a pickup truck bed. While the device can be used to removably secure any device, the preferred embodiment of this invention deals with a gripping section 22 that has one or more circular grips with approximately 90 degrees of open space at the top of the circular grip, such that a round pole 50 such as that found on a pool cleaning tool can be retained. In this figure, the base unit 1 has been secured by the means of attachment to the side 30 of the bed of the pickup truck. When the pickup truck bed is down, as in this figure, a pool cleaning technician can remove pool cleaning supplies from the pickup truck bed without the need to remove the pool cleaning tool. The tool can be easily removed by pulling on the pull head of the pin (not visible in this figure), and removing the entire gripping unit. Because the gripping unit is relatively small and light compared with the pool cleaning tool, a pool cleaning technician can easily carry the tool and gripping unit to the pool, perform the pool cleaning functions, then replace the gripping unit back into the base unit and drive on to the next job site.

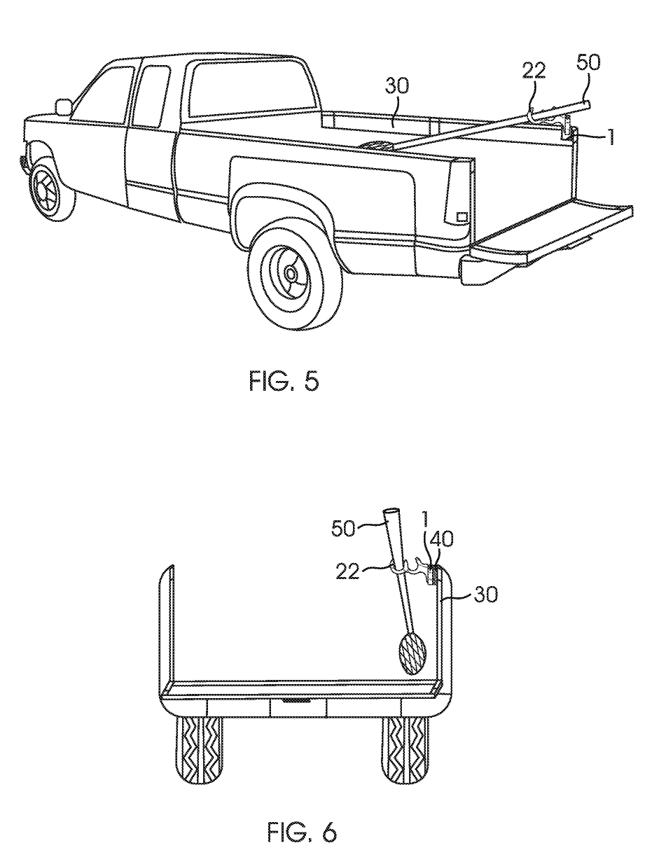

FIG. 6 is an end view of the device with a pool pole attached to it, with the device attached to the side of a pickup truck bed. The round pole 50 of the pool cleaning tool extends from the portion of the pickup truck bed closest to the cab out slightly beyond the tailgate portion of the pickup truck, shown here in a “down” position. The round pole 50 is removably gripped by the gripping section 22 of the gripping unit. Because the tripping section is made from a slightly flexible material such as plastic, the round pole 50 can be forced into the gripping section with a slight amount of force, and removed therefrom with an equally slight amount of force. The slightly encircling, pincering ends of the gripping section 22 are made, in this preferred embodiment, of a semi-flexible material such as plastic, such that a pole can be inserted and removed with a minimum of effort, and yet the pole is retained between the pincering ends while the truck is being driven to a pool. Because the base unit 1 is attached to an upper location on the side of the pickup truck bed, the gripping section 22 holds the pole 50 just slightly above the top of the tailgate of the pickup truck bed, thereby putting the pole in a position where it not only can be easily removed for use, but also avoids scratching the top of the tailgate.

FIG. 7 is a cross-sectional view of the pin device which allows for selective retention or release of the gripping unit. The base unit, generally indicated by reference number 1, has two side sections, 71 and 72. There is a hole 12 in side section 72. On the exterior side of side section 72 is a pin sleeve 73, which is a cylindrical sleeve defining a hollow interior cavity. At the top of the pin sleeve is a top cap 74, which is a cylindrical covering extending from the outer edge of the pin sleeve inward to define a cylindrical opening slightly larger in diameter than the shaft 11 of the pin. Attached to the underside of the top cap, at a point of attachment 75, is one of end a spring 77. The other end of the spring 77 is attached at a second point of attachment 76 to the shaft 11 of the pin, at a position approximately halfway down the shaft of the pin from the pull head. As a user of the invention pulls in direction 80, the spring 77 compresses, and the shaft 11 is removed from the female coupling section 79, thereby allowing for a gripping unit to be inserted or removed from the base unit 1.

What I claim is:

1. A device comprising
a base unit, with a back, two sides, and a front, and where the base unit has a cut-out portion creating a female coupling, where the cut-out portion is designed so that a gripping unit can be secured to the base unit, a pin, a spring, and a pin sleeve, where the pin and pin sleeve are located on the side of the base unit and the pin comprises a pull head, two spring anchors, and a shaft, where the pin sleeve is attached to the side of the base unit and comprises a hollow cylinder and a top cap, where the top cap has a hole in it, and where the pin comprises a pull head, which is a flat section of the pin which is located on the outside of the top cap of the pin sleeve, a shaft which extends at a perpendicular angle to the direction of the pull head, where the diameter of the shaft is slightly smaller than the diameter of the hole in the top cap, and where the shaft has at its juncture with the pull head a spring anchor, which is a point of attachment with means of attachment adequate to engage one end of the spring, where the spring is housed in the pin sleeve, and where the pin sleeve has a second point of attachment at its juncture with the side of the base unit, which is a point of attachment with means of attachment adequate to engage the other end of the spring, such that it its resting position, the spring expands and forces the spring anchor against one side of the base unit, thereby forcing the shaft to a fully extended position, where in the fully extended position the end of the shaft extends into the female coupling, thereby preventing any object inserted into the female coupling from falling out of the female coupling, and when a user of the invention pulls out on the pull head, the spring is compressed, thereby allowing the end of the shaft to be removed from the female coupling,
where the base unit is made from a strong, semi-flexible material such as metal or hard plastic,
means of attachment by which the base unit can be attached to a surface,
a gripping unit, where the gripping unit has a male coupling section, where the male coupling is designed to fit in the female coupling of the base unit, and a gripping section, where the gripping section is comprised of a one or more circular sections, where each of the one or more circular sections has an opening at the top of the circular section, where the opening is adequately wide to allow an object to be inserted into the circular section, where the gripping section is comprised of a material which is slightly pliable, such that a round, metal pole slightly larger that the opening can be forced through the opening and removably secured within the circular section, and where the round, metal pole can be removed from the circular section by pulling up upon the round, metal pole,
where the gripping unit can remain attached to the object while the object is in use or while being transferred from the base unit to some other desired location, and where the gripping unit can, while inserted in the base unit, hold the object above the portion of the vehicle to which the base unit is attached.

2. The device of claim 1, where the base unit is secured to a vehicle and the gripping unit is designed to accommodate one or more round poles of various shapes and sizes.

3. The device of claim 2, where the gripping unit is designed to accommodate one or more poles, where each of the one or more poles is a handle portion of a pool-cleaning device.

4. The device of claim 2, where the gripping unit is designed to accommodate one or more poles, where each of the poles is a handle portion of a piece of gardening equipment.

5. The device of claim 1, where the gripping unit additionally comprises a gripping section in a roughly rectangular shape, where the gripping section is designed to accommodate an object which is substantially flat and thin, such as a set of skis or the side of a ladder.

8. The device of claim 1, where the means of attachment by which the base unit is secured to a vehicle is screws.

9. The device of claim 1, where the means of attachment by which the base unit is secured to a vehicle is 2-sided tape.

10. The device of claim 1, where the vehicle is a pick-up truck where the base unit is secured to the bed of the pick-up truck, and the gripping unit is designed to accommodated one or more round poles of various shapes and sizes, and the gripping unit holds the object above the level of the sides of the bed and the tailgate of the pick-up truck such that the object does not scratch the paint of the tailgate or sides of the bed of the pick-up truck.

11. A method of removably attaching an object to a vehicle comprising
securing the base unit of claim 1 to a vehicle,
attaching the gripping unit to the base unit,
inserting the object into the gripping unit,
moving the vehicle from one location to another,
removing the gripping unit from the base unit, and
using the object while the object is still attached to the gripping unit.

12. The method of claim 12, where the elongated member is a pole of a pool-cleaning device.

13. The method of claim 12, where the elongated member is a pole of a gardening tool.

14. The method of claim 12, where the means of attachment by which the base unit is secured to a vehicle is 2-sided tape.

15. A method comprising
securing the base unit of claim 1 to a vehicle, attaching an elongated member or members to the gripping unit of claim 1, attaching the gripping unit to the base unit,
moving the vehicle from one location to another,
removing the gripping unit from the base unit,
carrying the elongated member or members while the elongated member is still attached to the gripping unit to another location, and
removing the elongated member or members from the gripping unit.

15. The method of claim 14, where the elongated member is a pole of a pool-cleaning device.

16. The method of claim 14, where the elongated member is a pole of a gardening tool.

17. The method of claim 16, where the means of attachment by which the base unit is secured to a vehicle is 2-sided tape.

18. The method of claim 14, where the means of attachment by which the base unit is secured to a vehicle is 2-sided tape.
